(19) United States
(12) Patent Application Publication
(10) Pub. No.: US 2026/0262869 A1
(43) Pub. Date: Sep. 10, 2026

(54) Liquid and/or gas pressure vessel and method of use

(71) Applicant: Williams MINJOE, Nutley, NJ (US)

(72) Inventor: Williams MINJOE, Nutley, NJ (US)

(21) Appl. No.: 18/848,592

(22) PCT Filed: Nov. 6, 2023
(86) PCT No.: PCT/US2023/078865

§ 371 Date: Sep. 19, 2024

Related U.S. Application Data
(60) Provisional application No. 63/423,019, filed on Nov. 6, 2022.

(51) Int. Cl. A47J 31/057; A23F 5/26; A47J 31/043; A47J 31/053; F03B 13/00

(52) U.S. Cl. CPC A47J 31/0576; A23F 5/262; A47J 31/043; A47J 31/053; F03B 13/00

(57) ABSTRACT

The present invention and method of use is in the field of fluid dynamics or more specifically pressure vessels/boilers and even more specifically coffee makers and their methods of use. Brewing methods usually don't allow steam to be part of the brewing process, which could be beneficial when pre-treating the material for brewing. Furthermore, current methods don't have a way for the user to select if they want steam and/or liquid to brew their material. Additionally, many other pressure vessels and their methods of use can benefit from having the ability to choose what fluids come out of an opening from the same vessel. The present invention is a way to control fluids with different densities, different states of matter, just by manipulating the pressure within the vessel with valves that are attached to the openings of the pressurized vessel. A pressure apparatus that can extract liquid and/or gas from and/or drawn into a vessel that has a pressure differing from that of the atmosphere or differing from outside of the vessel is what this abstract is presenting. The pressure can be generated via heating the fluids within the vessel or negative pressure can be generated via cooling of the fluids within; by adjusting some valves the user can use said pressure to extract and drawn liquid and/or steam from/to the pressurizing chamber. An interesting position about the liquid and/or gas extraction from a pressurized vessel creates an opportunity where the liquid and/or gas produced from the vessel can be harnessed for electrical energy. Which further creates an opportunity to create a pressure vessel that can brew coffee and generate electricity via hydro and/or turbo generation; Finally, if the vessel can fold into itself to make it portable, it would add an extra layer of utility to the simply beneficial ability to control the fluids in a vessel.

The present invention claims priority to provisional application#63/423,019 and if applicable provisional application#63/345,905.

### BACKGROUND OF THE INVENTION

A pot of boiling water plays an important role when it comes to civilization. Humans have been advancing ways to control fluids since the beginning. From a cup of tea to nuclear power, a boiling pot of water transforms our daily life.

The inspiration for a better solution to liquid/gas/pressure control was initiated when I first saw the vacuum coffee apparatus, invented by Loeff of Berlin in the 1830's.

When it comes to prior art, Mr. RHO YOUNG GYU (publication #: KR20180036221) of South Korea, and Mr. WILLIAMS (publication #: 2022/147360) from the USA come the closest to the present invention. Their claims state that the liquid can be controlled by opening a spout.

The difference between the present invention and ones formerly presented by RHO and WILLIAMS is the ability to manipulate the gas/steam produced in the bottom chamber through the same channel/opening liquid flows when under pressure.

Moreover, the present invention claims the apparatus may control the amount of pressure within the pressurizing chamber when prior art, specifically that of RHO and WILLIAMS does not reflect this.

There are other notable inventions on coffee brewing methods and fluid dynamics that relate to the present invention. Though none present the ability to extract/draw liquid and/or gas in the same opening/channel.

This small adjustment is beneficial because the user may pre-treat their brewing material with steam before fully submerging the material with hot water. Allowing for better extraction of brew and creating a pleasant fragrance. Furthermore, the user may use the present invention as a steamer as opposed to a liquid dominant application. Moreover, the present invention can adjust how much liquid and/or gas the channel delivers, providing precise control of all fluids in the apparatus. In addition, the present invention can adjust how much pressure the apparatus builds before using the pressure for its intended purpose. For example, creating an espresso beverage is difficult without pressure. Another example is a water heater for a household; that may produce hot water for a bath/shower and/or steam to switch to a steam room.

Furthermore, the present invention claims the user may modify the apparatus to utilize the liquid and/or gas extracted. Additionally, the present invention claims it can be compact and portable, in which the parts may fit into the boiling chamber, which can be taken with an individual easily; excellent for camping and other extracurricular activities.

The benefits of this system are not limited to brewing. I imagine that it enhances the way scientists perform experiments. I'm no nuclear engineer, but I imagine this might work to create layers of safety and/or enhance overall performance of nuclear power plants. Additionally kegs and pressurized liquid and/or gas containment vessels, like a gas cylinder, can benefit from the methods of this present invention. Furthermore, the present invention may benefit a carburetor, as a carburetor relies on the mix of air and liquid.

Another notable difference between the present invention and previous claims is the ability for the present invention to create a brew and generate electricity via a hydro and/or turbo generator. Therefore, a portable hydro and/or turbo generator, that can also extract a brew.

### BRIEF SUMMARY OF THE INVENTION

The present invention is a way of controlling fluids from or to a chamber. More specifically, controlling liquid and/or gas from or to a pressurizing vessel from at least one opening in the pressurizing vessel. Furthermore, it is a way of using valves to redirect pressure to move liquid and/or gas from or to a vessel through at least one opening. Additionally, heat can be applied to the vessel, to boil a liquid within to pressurize the pressurizing chamber to force liquid and/or gas from the pressurizing chamber. The heated liquid can be moved and used to extract substances such as coffee. The liquid and/or gas extracted from/to the pressurizing vessel can be used to create electricity.

The present invention is an apparatus that allows control of fluids in multiple states of matter or densities through the same opening provided the fluids are under pressure. Furthermore, the pressure may be induced by the change of liquid to gas (water to steam) via a heat source, or the change of gas to liquid via condensation. The bottom chamber is a vessel with at least one opening at the top where a fluid controlling assembly may be placed. The fluid controlling assembly has at least one opening and a respective valve which can open and close the opening. The opening on the fluid controlling assembly is a channel extending into the liquid in the bottom chamber. The channel has a valve that opens a vent on the channel, which is in contact with the vapor, or above the waterline in the bottom chamber. Moreover, the fluid controlling assembly may have a minimum of two openings which have their respective opening valves and respective channel with a vent that may be adjusted on the respective channel. All the openings/vents within said present invention are adjustable to open, close, partially open, and partially close. Which provides precise control of all fluids within the process.

### BRIEF DESCRIPTION OF DRAWINGS

FIG. 1, shows the a bottom chamber(1) with a handle(2) being filled with a portion of liquid water(100), and 101 as the waterline(101).

FIG. 2, shows the bottom chamber(1) filled with a portion of water(100) and a fluid controlling assembly(10) being fit securely onto the opening of the bottom chamber(1). The fluid controlling assembly(10), has two channels(11,12) that have their respective main valve(11m,12m), a vent(11n,12n) and respective valve(11v,12v). Channel(12) is fitted with a metal mesh filter(31b) and a porous ceramic filter(31a) within filter housing(30,31b) that fits the opening(41) on the bottom of the upper chamber(40).

FIG. 3, shows the apparatus(1000) put together and all valves (11m, 11v,12m, 12v) in the opened position. Heat(400) in the form of fire(400) from a stove heats water(100) in the bottom chamber(1), creating steam(200) which is directed out of both channels(11,12) via the open vents(11n, 12n), where the steam(200) is both, led out of a spout on channel(11) and in channel(12) is led up through filters(31a,31b) into the upper chamber(40) where said steam(200) is met by coffee grounds(300) within said upper chamber(40).

FIG. 4, shows that by adjusting both vent valves(11v,12v) to partially open, the apparatus(1000) can extract both liquid(100) and steam(200) from both channels(11,12). Positive pressure(201) in the form of steam(200) accumulates faster than it can escape through the vents(11n,11m) and pushes liquid(100) out through the channels(11,12) that mixes with steam(200) by the partially open vents(11n,12n). The mixture of steam(200) and water(100) is led out of channel(11) but is led into an upper chamber(40) in channel(12) where it meets coffee grounds(300) and starts brewing together to create liquid coffee(500).

FIG. 5, shows only liquid(100) moving into the upper chamber(40). By shutting ball valve(11m) and vent valve(12v) on channel(12). This forces liquid(100) to move up channel(12) into the upper chamber(40) where it brews with coffee grounds(300) creating liquid coffee(500).

FIG. 6, shows that if you open vent valve(12v) enough, while coffee is brewing(FIG. 5) you can allow the brew(500) back down into the bottom chamber(1). Steam(200)/pressure(201) escapes from the vent(12n) and bubbles up through the brew in the upper chamber(40).

FIG. 7, shows another way of bringing the liquid from the top chamber(40) down to the bottom chamber(1) while brewing is taking place and liquid is being boiled in the bottom chamber(1). By opening the main valve(11m) on channel(11) and vent(11n) is opened and coffee is brewing in the upper chamber(40) the mixture of coffee grounds flows back down through filters(31a,31b) into the bottom chamber(1), due to the loss of pressure in the bottom chamber(1). While main valve(12m) is opened on channel(12). Returns to the bottom chamber(1), as brewed filtered coffee(500).

FIG. 8, shows yet another way of bringing the liquid from the top chamber(40) down to the bottom chamber(1), while the other channel(11), is closed. When the user determines the mixture of hot liquid(100) and ground coffee(300) is complete, remove the heat source(400). After some time, the steam/vapor(200) in the bottom chamber(1) starts to condense into liquid and creates negative pressure(202) within the bottom chamber(1), which pulls the brew from the top chamber(40) through filters(31a,31b) into the bottom chamber(1) as a brewed filtered coffee.

FIG. 9, is a continuation of FIG. 8 and shows that if there is enough negative pressure, atmospheric air(205) is drawn into the bottom chamber(1) until the pressure within the bottom chamber(1) closely resembles atmospheric pressure.

FIG. 10, shows the brewed filtered coffee(500) being heated(400) in the bottom chamber(1) and channel(12) is closed via valve(12m) and channel(11) is opened with the vent(11n) on channel(11) closed. This forces brewed filtered coffee(500) out of channel(11) which can be served in a mug.

FIG. 11, shows liquid(100) as brewing liquid coffee(500) circulating by moving from the bottom chamber(1) into channel(11) which has an elongated spout that directs liquid into the top of the upper chamber(40) where the liquid meets coffee grounds and eventually makes its way down into the bottom chamber(1). This is possible due to the restriction in the partially opened valve(12m).

FIG. 12, shows the heat source(400) can be magnified or focused(452) sunlight(451). The sun(450) beams light(451) into the magnifying glass(453) that focuses(452) the light on the bottom chamber(1). Additionally, there is a reflective material(454) arced in a way that focuses(452) sunlight(451) onto the bottom of the bottom chamber(1). This causes the liquid(100) within the bottom chamber(1) to heat and create steam(200) which is partially restricted by vent valves(11v,12v), forcing both liquid(100) and steam(200) out of both channels(11,12). Channel(11), is fixed with a generator(80) and the steam and liquid mixture(200,100) spins a turbine(81) that spins a rotor(82) in a stator(83) and electricity flows through a set a wires(84) into a bulb(85) that lights up. Therefore, the present invention can be a portable hydro and/or turbo generator, that can produce renewable energy.

FIG. 13, shows the channels(11,12) and it's relevant parts said thus far dismantled and placed into the bottom chamber(1), while the upper chamber(40) is placed upside down into the bottom chamber(1), and the fluid controlling assembly(10) that's dismantled acts as a lid that holds all of the said parts within the bottom chamber(1). This is to show that the apparatus(1000) and the present invention can hold all of the components of the apparatus within the bottom chamber(1) for a compact and portable apparatus that may even fit in your hand. It should be stated that the present invention can be any size but for portability FIG. 13 represents a smaller apparatus(1000) for the compact portability of a coffee maker and hydro and/or turbo generator.

### DETAILED DESCRIPTION OF THE INVENTION

The present invention is a method of directing liquid and/or gas from/to a vessel from at least one opening provided the fluids are under pressure. The pressure can be derived from heating a substance of liquid within a pressurizing chamber. The liquid that turns to steam accumulates and starts applying pressure on the liquids within the pressurizing chamber. Valves attached to the openings of the bottom/pressurizing chamber can be adjusted to:

The apparatus has a bottom chamber with at least two openings, which can be opened, closed, or partially opened or closed, that extend into the bottom chamber where a portion of liquid is boiled and a vent with a respective valve that can be opened, closed, or partially opened or closed, that interacts with the vapor/steam within the bottom chamber. The first channel extends out of the bottom chamber in the form of a spout and the second channel extends through a set of filters into an upper chamber.

The set of channels/openings and valves that attach as a lid onto the bottom chamber in this embodiment of the apparatus is referred to as the fluid controlling assembly.

The boiling chamber/bottom chamber can come with safety vent(s) that release pressure in the vessel if the pressure reaches the safety vent(s) release thresholds. Because the safety vent(s) do not interfere with the function of the apparatus and its methods of use, it will not be mentioned henceforth.

Throughout the course of this specification of the present invention, when water is described, it should be acceptable to find that liquid and the like, shall be interchangeable with water or the denser fluid. Furthermore, when describing steam, it should be acceptable to find that gas, vapor, and the like, shall be interchangeable with steam or the less dense fluid.

The valves within this specification are separated and independent of each other, but it should be recognized that the valves can be combined or can be dependent of each other. These valves are a crude way of showing the process of the present invention.

Pressure of the apparatus within this specification will be focused on heating/cooling the fluids within the pressurizing chamber to create pressure. Though, it should be stated that the pressure within the specification can be produced by any means. Therefore, heat is used as a means of creating a difference in pressure within the pressurizing chamber and atmospheric pressure or outside the pressurizing chamber. Examples of difference in pressure can include, but are not limited to, a chemical reaction of liquids within the pressurized chamber, a pump that's applied to one of the openings of the pressurized chamber or air moving at high speeds outside of the apparatus.

The bottom chamber where the liquid is boiled shall be interchangeable in language with lower chamber, pressurizing chamber, boiling chamber, or pot, throughout the course of this specification.

The heating source or heating element of the specification is meant to be an open flame, like a stove top burner. However, the heating source can be any type of heat source; focused solar, magnified solar, thermos ventilation from within the earth, or an electrical source such as an electric kettle.

The processes and functions within the specification can also be programmed to an electrical kettle to select and time the openings and valves within the apparatus to direct the flow of liquid and/or gas to curate to the user.

During this specification, brewing coffee is the main example when extracting a material for brewing. Though it should be noted that the material can be any material that can be extracted or benefited from the methods of the present invention.

The connections between the parts of the apparatus within this application should be thought of as secure threaded connections. The connections between parts of the apparatus can be any secure connection that the world/user finds suitable. The drawings are just a crude reflection of science and not technical drawings for a product.

The materials of the present invention should be thought of as stainless steel unless otherwise specified. Though, should be stated that any material that is able to hold liquid and control valves without breaking a seal can be used. What would be most excellent is if the bottom and top chambers were made of glass, but this might be hazardous.

The present invention can be better understood by reading the following while referring to the drawings of this application.

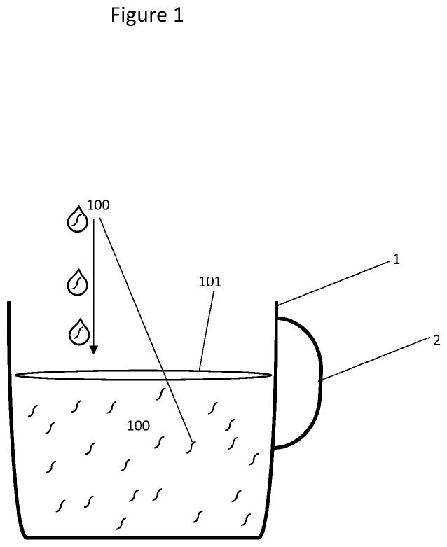

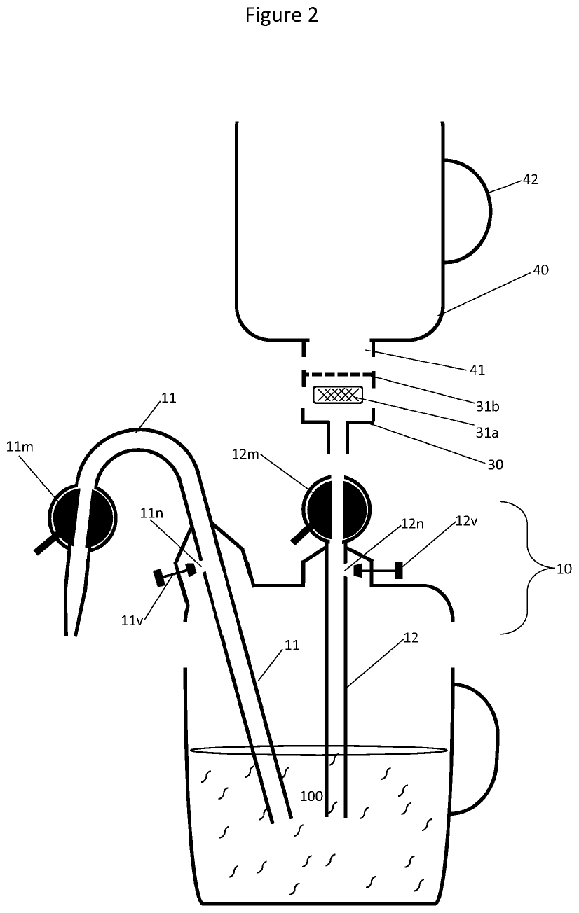

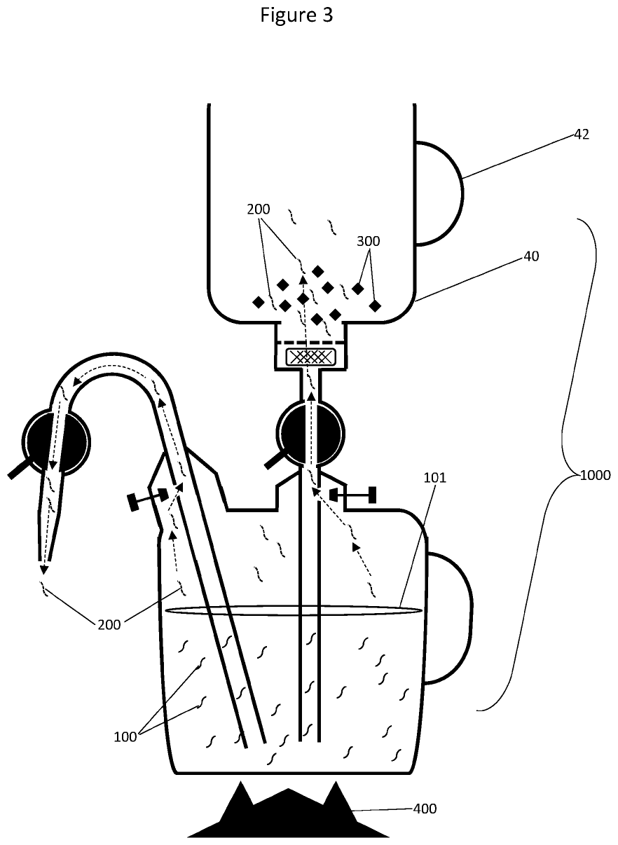

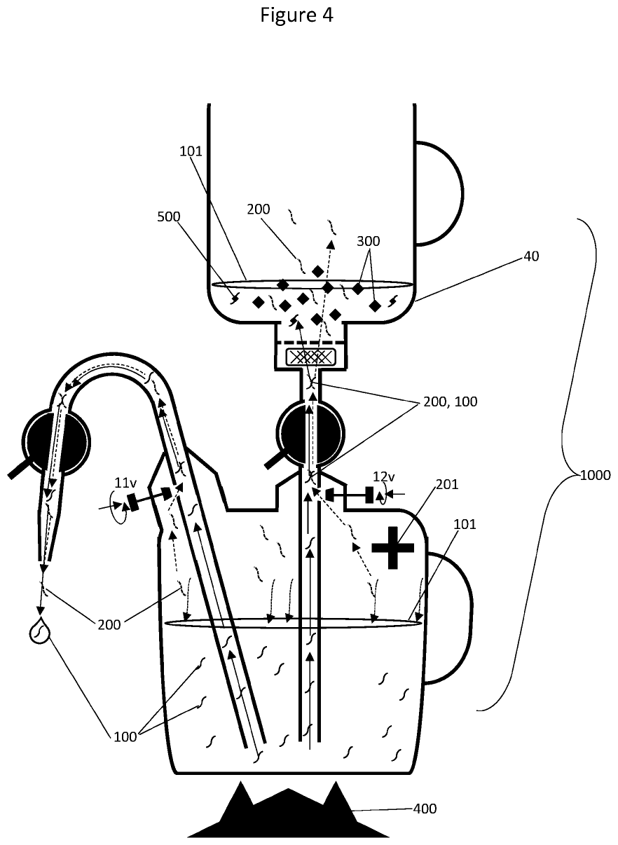

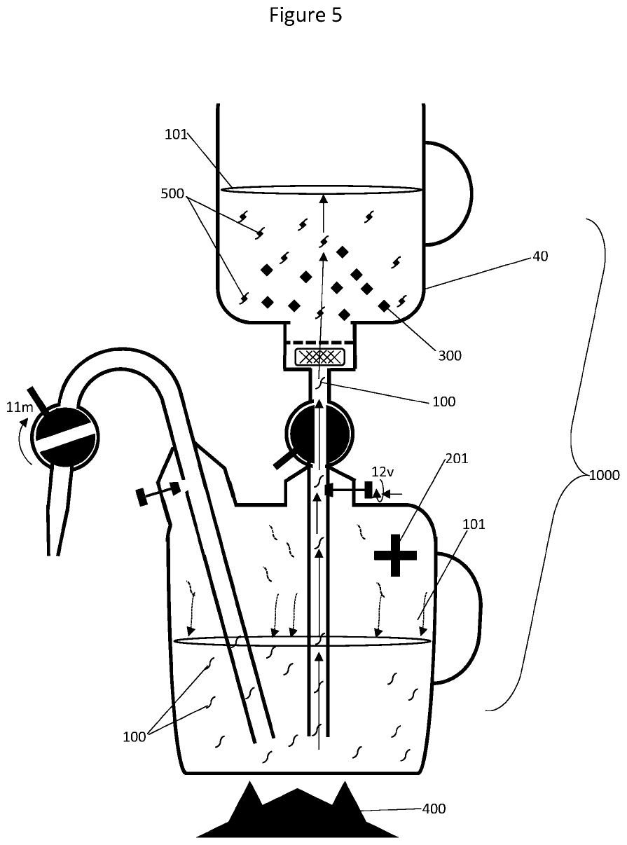

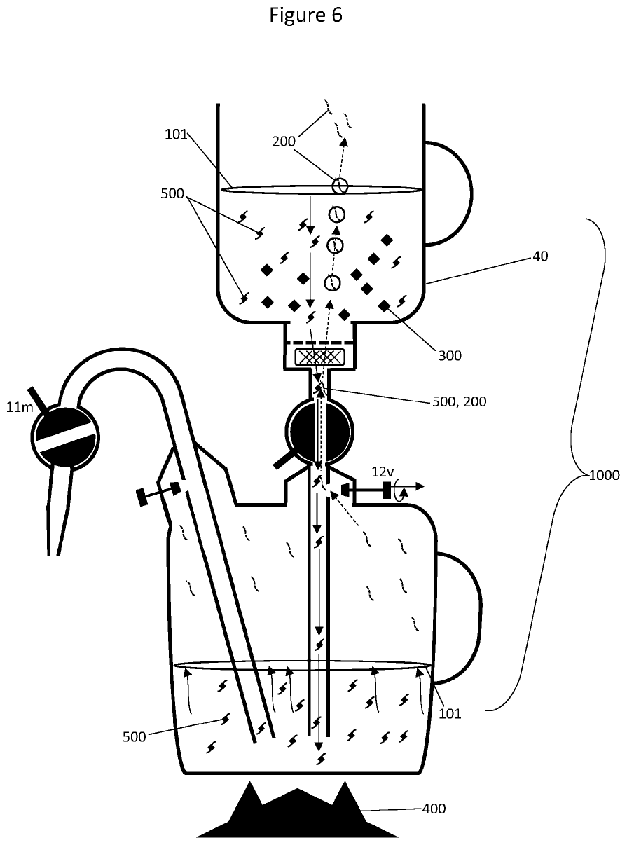

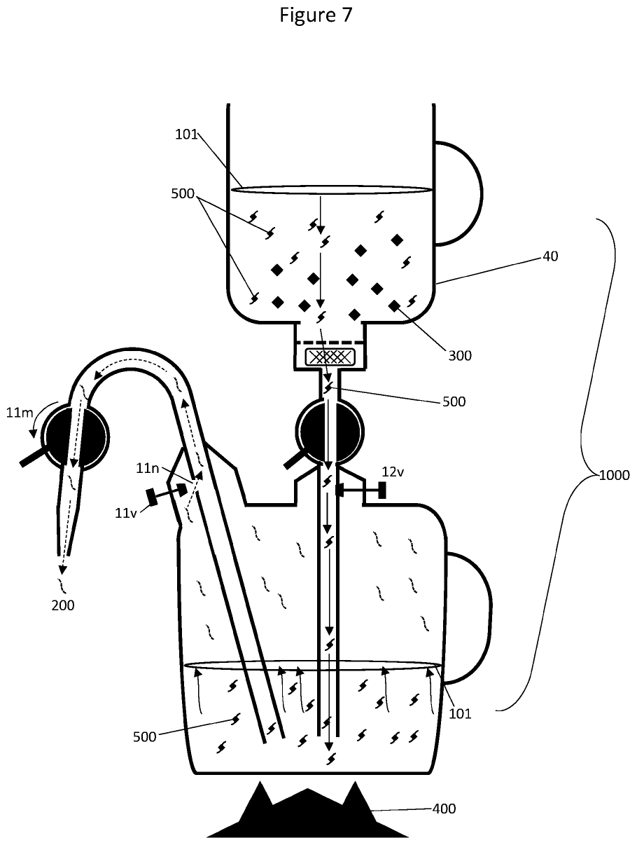

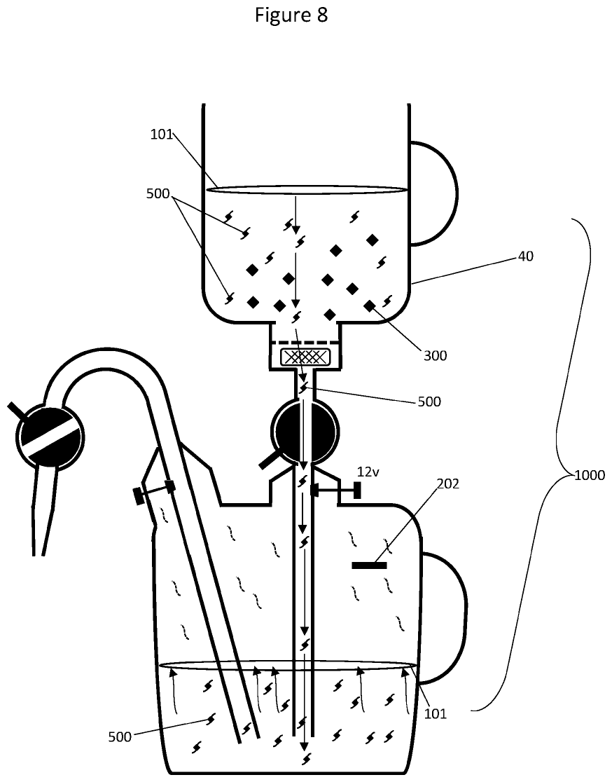

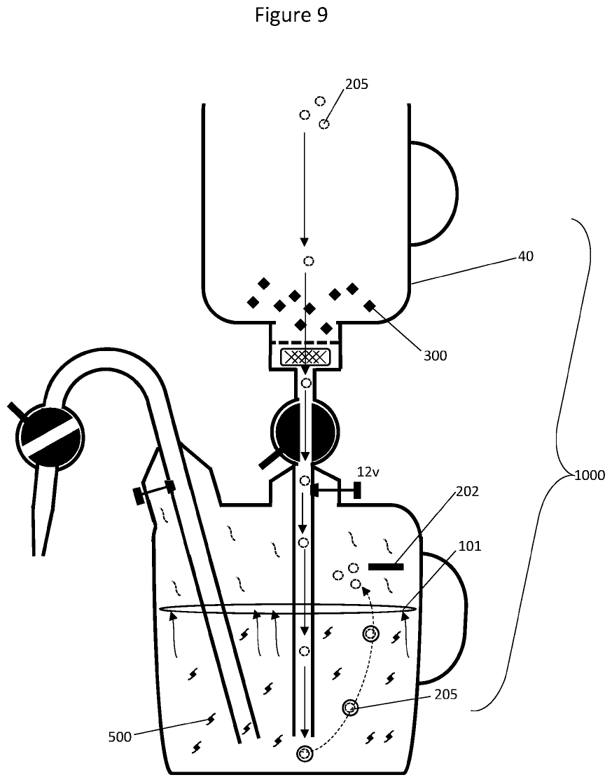

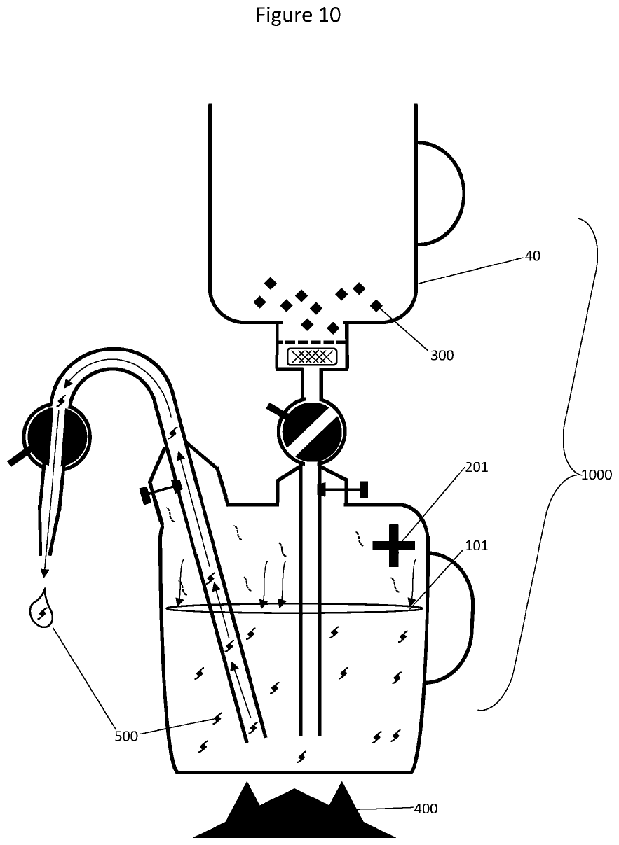

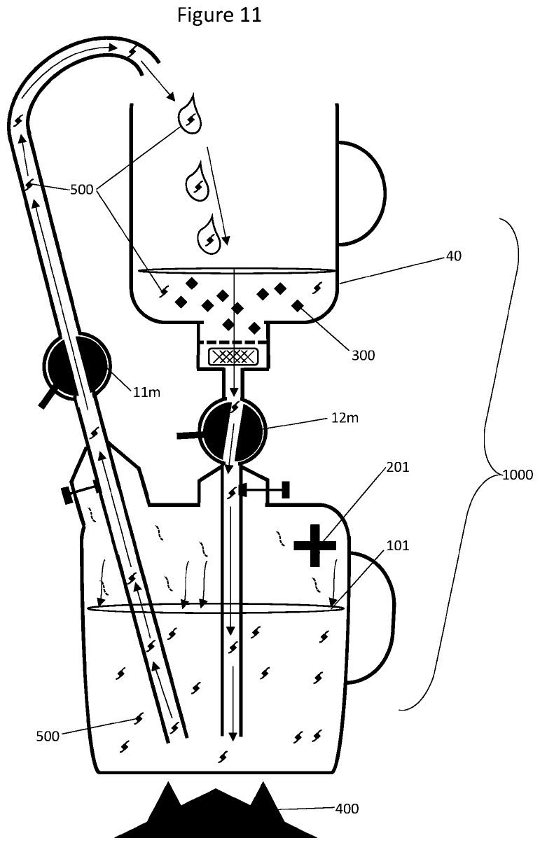

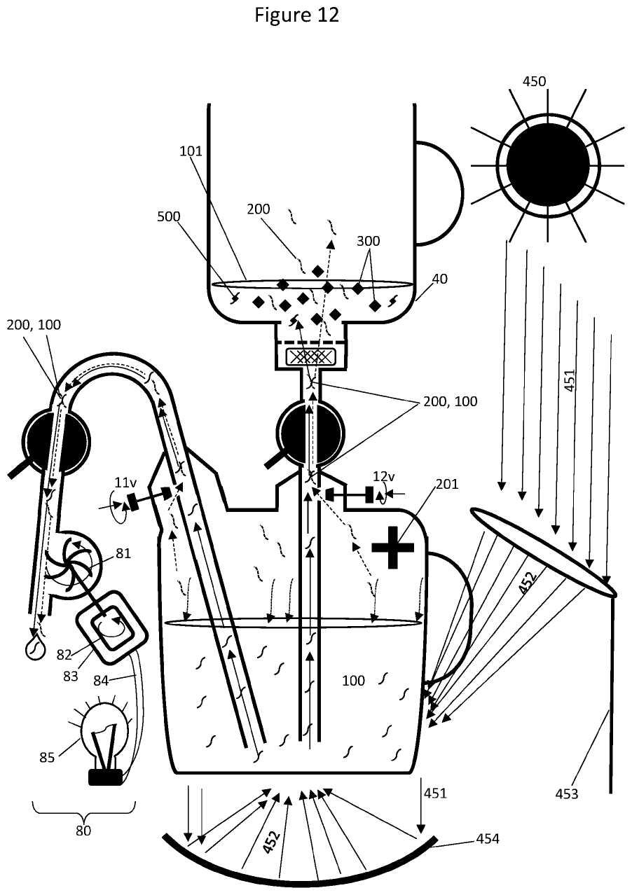

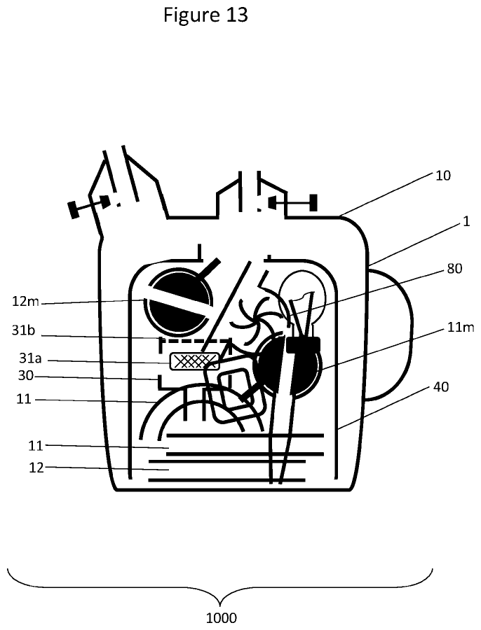

A quantity of liquid(100) is poured into the bottom chamber(1)(FIG. 1). The bottom chamber(1) is a vessel that can hold liquid and is open at the top. Then, a fluid controlling assembly(10), with two openings(11,12)/channels(11,12) with their respective valves(11m,12m) that opens, closes, partially opens, and partially closes the openings/channels(11,12), a respective vent(11n,12n) on each channel(11,12) that is controlled by respective valves(11v,12v) that opens, closes, partially opens, and partially closes said vents(11n, 12n) is secured on to opening of the bottom chamber(1)(FIG. 2). The channels(11,12) extend into the bottom chamber(1) and is in contact with the liquid(100) within the bottom chamber(1)(FIG. 2-3). The first channel(11), is fixed with a spout and the second channel(12) is fixed with filters(31a,31b) within filter housing(30,31b), that fits into the bottom opening(41) of the upper chamber(40)(FIG. 2-3). Heat(400) is applied to the bottom chamber(1) to boil the quantity of liquid(100) within, creating steam(200) which escapes through both openings(11,12) via the respective open vents(11n, 12n)(FIG. 3). The steam(200) forced out of apparatus(1000) via the first channel(11) can be used to steam(200) milk in a different vessel(mug)(not pictured), while the steam(200) forced through second channel(12) moves from the bottom chamber(1) through the set of filters(31a,31b) into the upper chamber(40) where it is met by coffee grounds(300), that has been placed into the upper chamber(40) and steams(200) the coffee grounds(300)(FIG. 3). Both vent valves(11v,12v) are adjusted to partially opened to restrict some of the pressure(201) created by steam(200) that accumulates in the bottom chamber(1) forcing some liquid(100) and some steam(200) through both the first and second channel(11,12)(FIG. 3). The mixture of liquid and steam(100,200) exits the first channel(11) through the spout and the mixture of liquid and steam(100,200) through the second channel(12) meets the coffee grounds(300) in the upper chamber(40) where hot liquid(100) accumulates and starts to brew with the coffee grounds(300) in the upper chamber(40)(FIG. 4). By closing first channel(11) via valve(11m) and shutting vent(12n) via the vent valve(12v) on the second channel(12), only liquid(100) is forced through the second channel(12) into the upper chamber(40) where it is met by the coffee grounds(300) and brews together within the upper chamber(40), creating liquid coffee(500)(FIG. 5). The liquid coffee(500) mixture(300,100) in the upper chamber(40) can be sent back down through the filters(31b,31a) into the bottom chamber(1), while heat(400) is still applied, by either or a combination of opening valve(12v) and/or opening valves(11v) and opening valve(11m), which releases pressure(201) from within the bottom chamber(1) and allows flow of liquid coffee(500) back down in the bottom chamber(1) via gravity(FIG. 6-7). An alternative method of bringing the liquid coffee(500) back down into the bottom chamber(1) is to remove the heat source(400), which after some time will create negative pressure(202) within the bottom chamber(1) via condensation of steam(200) turning into liquid(100), drawing the liquid coffee(500) through filters, which allows liquid(100) and gas(200) to pass but does not allow solids(300) through, to the bottom chamber(1)(FIG. 8). If there is enough negative pressure(202) within the bottom chamber(1), after all of the liquid coffee(500) has been drawn from the upper chamber(40), atmospheric air(205) is drawn into the bottom chamber(1) until pressure within the bottom chamber(1) equalizes with atmospheric pressure, or pressure outside of bottom chamber(1)(FIG. 9). After the brewed filtered liquid coffee(500) is gathered back into the bottom chamber(1), the user may extract the liquid coffee(500) from the apparatus(1000) by either tilting(not pictured) the apparatus(1000) towards the exit spout of the first channel(11), while second channel(12) remains open, or close the second opening/channel(12) via valve(12m) and open the first channel(11) via valve(11m) and having vent(11n) closed and heat(400) is applied to create pressure(201) via steam(200) that applies pressure(201) on the waterline(101) within the bottom chamber(1), forcing brewed filtered liquid coffee(500) out of the first channel(11), which may be served into a mug or vessel of choice(FIG. 10). The apparatus(1000) may be configured in a way where the first channel(11) is directed towards the opening at the top of the upper chamber(40) and can circulate fluids from the bottom chamber(1) through and exiting the first channel(11) into the top chamber(40) down through filters(31a,31b) and back down to the bottom chamber(1); This is possible because valve(12m) on the second channel(12) is partially opened while the valve(11m) on the first channel(11) is fully opened and fluids like to flow in route of least resistance(FIG. 11). The heating element(400) thus far has been an open flame, but can be any heat source, such as focused(452) or magnified(452) sunlight(451), where sun(450) light(451) is directed and focused through a magnifying glass(453) and/or a reflective material(454) to heat the bottom chamber(1) that pressurizes fluids(100,200) which can be directed through the first opening/channel(11) attached with an electrical generator by the spout, spins a turbine(81) that spins a rotor(82) inside a stator(83), providing electricity to the bulb(85) through wires(84)(FIG. 12). When the user has finished with the apparatus(1000) the parts of the apparatus, including the upper chamber(40), may fit into the bottom chamber(1) and what's left of the fluid controlling assembly acts as a lid to confine the parts within the bottom chamber(1), creating a portable coffee apparatus that has the ability to generate electricity with hydro and/or turbo generation(FIG. 13).

1. A pressure vessel, comprising:
a lower chamber including a first opening and a second opening;
a first valve attached to said first opening and a second valve attached to said second opening;
said first opening connecting, by way of said first valve, to an external spout and said second opening connecting, by way of second valve, to an upper chamber; a selection mechanism usable to select configurations of said pressure vessel, wherein:
a first configuration of said configurations wherein both said first valve and said second valve are open such that steam from heated fluids in said lower chamber is directed into both said spout and said upper chamber;
a second configuration of said configurations wherein both said first valve and said second valve are closed such that steam from heated fluids in said lower chamber causes positive pressure within said lower chamber which, in turn, directs liquid into both said spout and said upper chamber;
a third configuration of said configurations wherein at least one of said first valve and said second valve is partially open and partially closed while heated fluids in said lower chamber is directed, in a variable amount of liquid and/or gas to be directed into through said spout and/or into said upper chamber;
a fourth configuration of said configurations wherein at least one of said first valve and said second valve is partially opened such that fluids cooling in said lower chamber creates negative pressure within said lower chamber which, in turn, draws liquid and/or gas therein from said spout and/or said upper chamber;
a fifth configuration of said configurations wherein at both said first valve and said second valve is closed such that steam from boiling liquid in said lower chamber causes positive pressure within the lower chamber which, in turn, directs liquid into said upper chamber through said spout.

2. A pressure vessel as in claim 1, wherein said positive pressure within said lower chamber is generated by any other means and said negative pressure within said lower chamber is generated by any other means.

3. A pressure vessel as in claim 1, wherein said spout is attached with a turbine that generates electricity.

4. A pressure vessel as in claim 3, wherein all said parts of the apparatus fit into the bottom chamber for portability.

5-7. (canceled)

8. A method of steaming and/or boiling material as in claim 5, wherein said boiling liquid circulates from a lower chamber through a spout directed into said upper chamber with an extractable substance, then back down through a filter into said bottom chamber.

9-10. (canceled)
